(19) United States
(12) Patent Application Publication
(10) Pub. No.: US 2004/0253037 A1
(43) Pub. Date: Dec. 16, 2004

(54) CAPLESS HOLDING DEVICE

(76) Inventor: Yoshio Noguchi, Saitama (JP)

Correspondence Address: WILLIAM B. PATTERSON, MOSER, PATTERSON & SHERIDAN, L.L.P., Suite 1500, 3040 Post Oak Blvd., Houston, TX, 77056, US

(21) Appl. No.: 10/828,723

(22) Filed: Apr. 21, 2004

(30) Foreign Application Priority Data
Jun. 3, 2003 (JP) 2003-158352

(51) Int. Cl. B43K 5/16

(52) U.S. Cl. 401/110

(57) ABSTRACT

The present invention provides a capless holding device which does not use any removable caps but which can reliably move a medium between a projected position and a housed position. The capless holding device includes a cylinder holding a refill that is movable between a projected position and a housed position. The cylinder includes a tip opening out of which a pen tip of the refill located at the projected position is projected and a housing section that seals the pen tip of the refill located at the housed position. A rotating cylinder is connected to the axial cylinder so as to relatively rotatively movable, an engaging projection integrally provided on the refill, a cam groove formed in the rotating cylinder to guide the engaging projection forward and backward in unison with rotation of the rotating cylinder, and a guide groove formed in the axial cylinder to guide the engaging projection in a rotating direction.

### CROSS-REFERENCE TO RELATED APPLICATIONS

This application claims benefit of Japanese patent application serial number JP 2003-158352, filed Jun. 3, 2003, which is herein incorporated by reference.

### BACKGROUND OF THE INVENTION

1. Field of the Invention

The present invention relates to a capless holding device that does not use a removable cap.

2. Description of the Related Art

As writing implements that do not use a removable cap in order to eliminate the need to remove it and the possibility of losing it, a capless holding device has been known which comprises a cylinder holding a writing member that is movable between a projected position and a housed position, the cylinder comprising a tip opening out of which a tip of the writing member located at the projected position is projected and a housing section that seals the tip of the writing member located at the housed position (refer to, for example, Japanese Patent Laid-Open No. 52-49123).

In the arrangement described in the above-mentioned document, a knock pipe is connected to the cylinder in order to knock the cylinder relative to the writing member. A projecting cam is integrally provided on the writing member. A cam groove is formed in the cylinder. The projecting cam and the cam groove cooperate with each other, and the projecting cam moves along the cam groove to allow the wiring member to move between the projected position and the housed position.

In the conventional capless holding device, the single cam groove guides the forward and backward movement and rotation of the projecting cam. However, it is disadvantageously difficult to reliably move the projecting cam.

The present invention is provided in view of these problems. It is an object of the present invention to provide a capless holding device that can reliably move a medium between a projected position and a housed position.

### SUMMARY OF THE INVENTION

To accomplish the above object, a capless holding device according to the present invention comprises a cylinder holding a medium that is movable between a projected position and a housed position, the cylinder comprising a tip opening out of which a tip of the medium located at the projected position is projected and a housing section that seals the tip of the medium located at the housed position. The capless holding device further comprises a rotor rotatively connected to the cylinder, an engaging projection provided on the medium, a cam groove formed on the rotor to guide the engaging projection forward and backward in unison with rotation of the rotor, and a guide groove formed on the cylinder to guide the engaging projection in a rotating direction. The cam groove, the guide groove and the engaging projection cooperate with one another in retracting the medium from the projected position, rotating the medium, and then advancing the medium to the housed position and in retracting the medium from the housed position, rotating the medium, and then advancing the medium to the projected position.

The engaging projection is guided by the cam groove formed on the rotor for guiding the engaging projection forward and backward by rotation of the rotor and the guide groove formed on the cylinder for guiding the engaging projection in the rotating direction. Consequently, the medium can be surely retracted from the projected position, rotated, and then advanced to the housed position. Conversely, the medium can be surely retracted from the housed position, rotated, and then advanced to the projected position.

The cam groove can be V-shaped and comprise a first cam groove and a second cam groove which are inclined in opposite directions relative to an axial direction, the guide groove can be U-shaped and comprises a first guide groove parallel with the axial direction, a second guide groove extending in a circumferential direction, and a third guide groove parallel with the axial direction, and the engaging projection can take the projected position when positioned both in the first cam groove and in the first guide groove and can take the housed position when positioned both in the second cam groove and in the third guide groove.

Using the first cam groove inclined relative to the axial direction, and the first guide groove which is parallel with the axial direction, the engaging projection can be guided forward and backward in the axial direction in unison with the relative rotation between the rotor and the cylinder. Accordingly, the medium can be moved forward or backward to the projected position or from the projected position. Furthermore, the engaging projection can be guided in the circumferential direction through the second guide groove extending in the circumferential direction so that the medium can be rotated. Moreover, using the second cam groove inclined relative to the axial direction, and the second guide groove which is parallel to the axial direction, the engaging projection can be guided forward and backward in the axial direction by the relative rotation between the rotor and the axial cylinder. Accordingly, the medium can be moved forward or backward to the housed position or from the housed position.

A junction between the first guide groove and the second guide groove can cross the first cam groove in front of a top portion of the V-shaped cam groove, and a junction between the third guide groove and the second guide groove can cross the second cam groove in front of the top portion of the V-shaped cam groove. This arrangement can prevent the engaging projection moving in the axial direction along the first guide groove and first cam groove, from reaching the top portion of the V-shaped cam groove and returning in the axial direction along the first guide groove and the second cam groove. Consequently, the engaging projection surely enters the second guide groove before reaching the top portion of the V-shaped cam groove. Similarly, the above arrangement can prevent the engaging projection moving in the axial direction along the third guide groove and second cam groove from reaching the top portion of the V-shaped cam groove and returning in the axial direction along the third guide groove and the first cam groove. Consequently, the engaging projection surely enters the second guide groove before reaching the top portion of the V-shaped cam groove. Thus, the medium can be reliably rotated after retracting in the axial direction.

The second guide groove can have a small first inclined portion and a small second inclined portion both of which are inclined in the axial direction and a transverse guide groove between the first inclined portion and the second inclined portion, and the transverse guide groove can cross the top portion of the V-shaped cam groove. When the engaging projection is guided along the transverse guide groove between the first inclined portion and second inclined portion of the second guide groove, the engaging projection is positioned in the top portion of the V-shaped cam groove. Then, the engaging projection passes through the first or second inclined portion and then moves along the first or second cam groove of the V-shaped cam groove. When passing through the first or second inclined portion, the engaging projection moves from the top portion of the V-shaped cam groove to the next cam groove to which the engaging portion is to move. Thus, the engaging projection can reliably enter the cam groove to which it is to advance and the medium can be reliably advanced after rotating.

The present disclosure relates to subject manner contained in Japanese Patent Application No. 2003-158352, filed on Jun. 3, 2003, which is expressly incorporated herein by reference in its entirety.

### BRIEF DESCRIPTION OF THE DRAWINGS

FIG. 1 is a longitudinal sectional view of an entire capless holding device according to the present invention;

FIG. 2 is an exploded perspective view illustrating an engaging projection of a refill, a guide groove on a cylinder, and a cam groove on a rotating cylinder;

FIG. 3 is a sectional view illustrating operations of the engaging projection of the refill, the guide groove on the axial cylinder, and the cam groove on the rotating cylinder;

FIG. 4 is a development illustrating operations of the engaging projection of the refill, the guide groove on the axial cylinder, and the cam groove on the rotating cylinder;

FIG. 5A is a plan view of the axial cylinder, FIG. 5B is a view seen from arrow b in FIG. 5A, FIG. 5C is a sectional view taken along line c-c in FIG. 5A, FIG. 5D is a sectional view taken along line d-d in FIG. 5C, and FIG. 5E is a development of the guide groove;

FIG. 6A is a sectional view of a rear cylinder and FIG. 6B is a sectional view taken along line b-b in FIG. 6A;

FIG. 7A is a side view of the rotating cylinder, FIG. 7B is a sectional view of the rotating cylinder, and FIG. 7C is a development of the cam groove on the rotating cylinder; and

FIG. 8 is a front view and a side view showing that the refill is rotated.

### DETAILED DESCRIPTION

An embodiment of the present invention will be described with reference to the drawings.

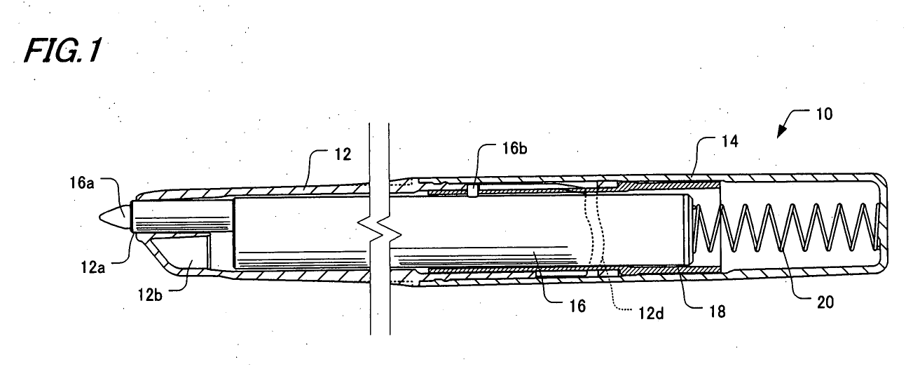

FIG. 1 is a longitudinal sectional view of an entire capless holding device according to the present invention. A rear portion of the drawing corresponds to the rotation of its tip portion of the drawing around its axis through 900.

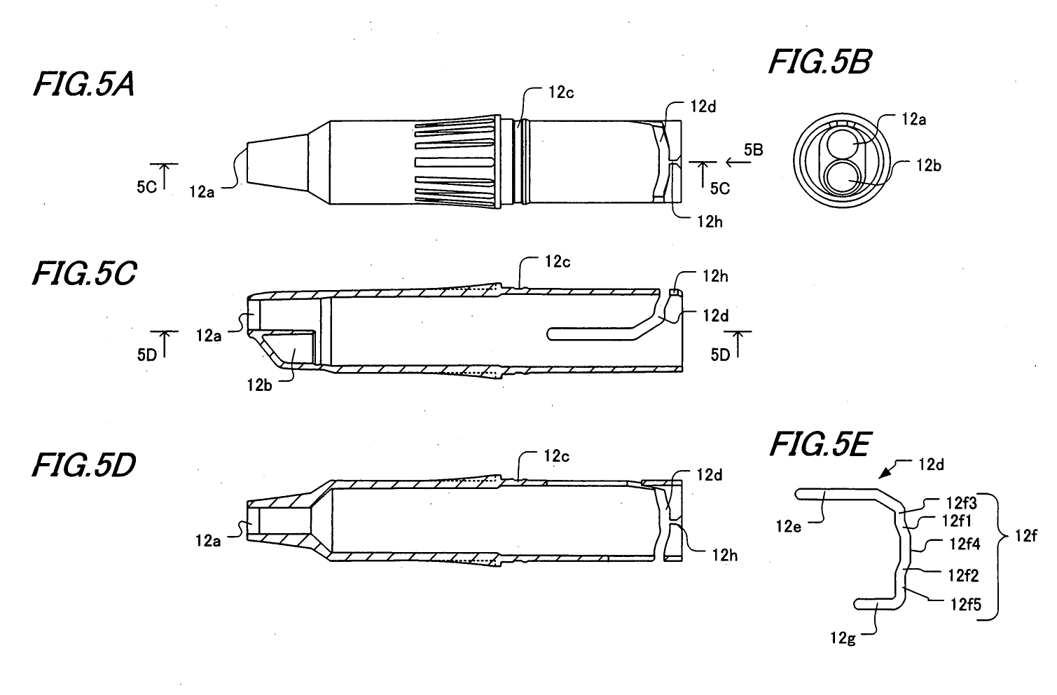

The capless holding device 10 comprises a cylinder 12 that holds a refill (writing member) 16 as a medium. A tip opening 12a is formed in the tip of the cylinder 12 to allow a pen tip 16a of the refill 16 to project out of the opening 12a. A concave housing section 12b is formed inside the tip of the axial cylinder 12 to seal the pen tip 16a of the refill 16. The tip opening 12a and the housing section 12b are each offset from the central axis and separated from each other at a predetermined angle, for example, 180° around the central axis as shown in FIG. 5.

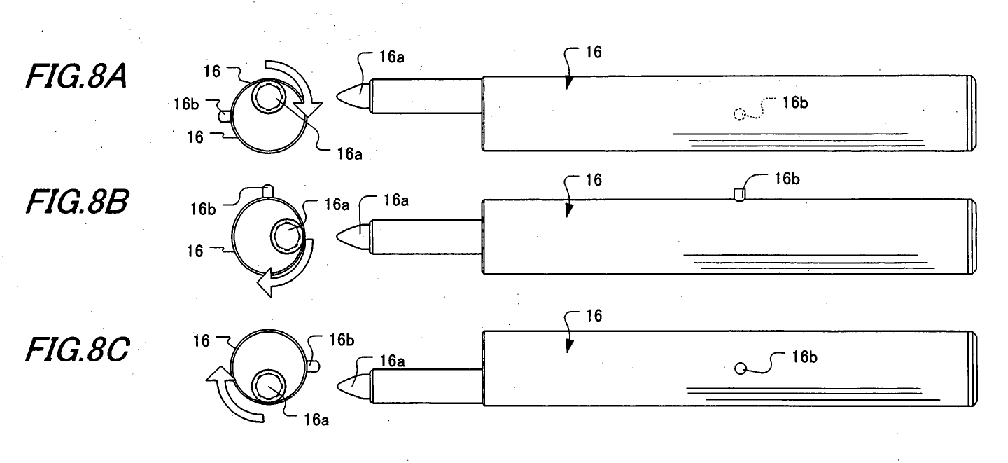

The pen tip 16a of the refill 16 is offset from the central axis in association with the positions of the tip opening 12a and housing section 12b as shown in FIG. 8.

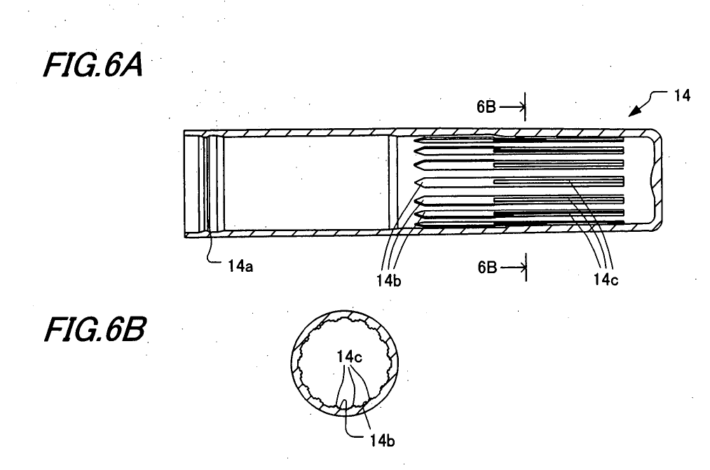

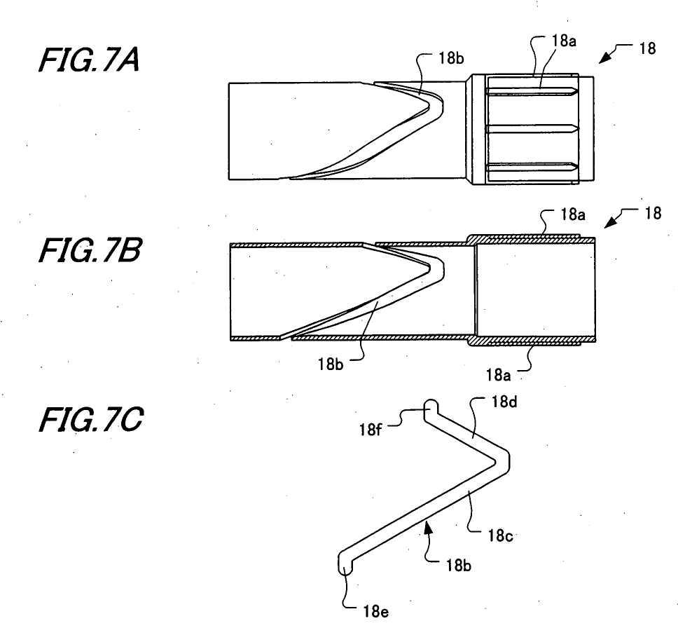

The capless holding device 10 comprises a rear cylinder 14 connected to a rear portion of the cylinder 12 so as to be rotatively movable relative to the cylinder 12 and to be immovable in the axial direction, and a rotating cylinder 18 which rotates integrally with the rear cylinder 14 and which is inserted into the cylinder 12 from its rear portion, the rotating cylinder acting as a rotor. As shown in FIG. 6, annular engaging ribs 14a are formed in a front portion of an inner peripheral surface of the rear cylinder 14 so as to engage relatively rotatably with an annular concave portion 12c (see FIG. 5) of the cylinder 12. Furthermore, rotation fixing ribs 14b are formed in a rear portion of the inner peripheral surface of the rear cylinder 14, and small retreat regulating ribs 14c are formed on the respective rotation fixing ribs 14b. On the other hand, rotation fixing ribs 18a are formed on an outer peripheral surface of the rotating cylinder 18 so as to engage with the rotation fixing ribs 14b as shown in FIG. 7. Thus, the rear cylinder 14 and the rotating cylinder 18 can be integrally rotated. The retreat of the rotating cylinder 18 is regulated by the retreat regulating ribs 14c of the rear cylinder 14, whereas the advancement of the rotating cylinder 18 is regulated by the cylinder 12. The rotating cylinder 18 is thus arranged so as to be rotatable relative to the cylinder 12 and to be immovable in the axial direction.

A spring 20 is accommodated in the rear cylinder 14 and urges the refill 16 toward the front of the device.

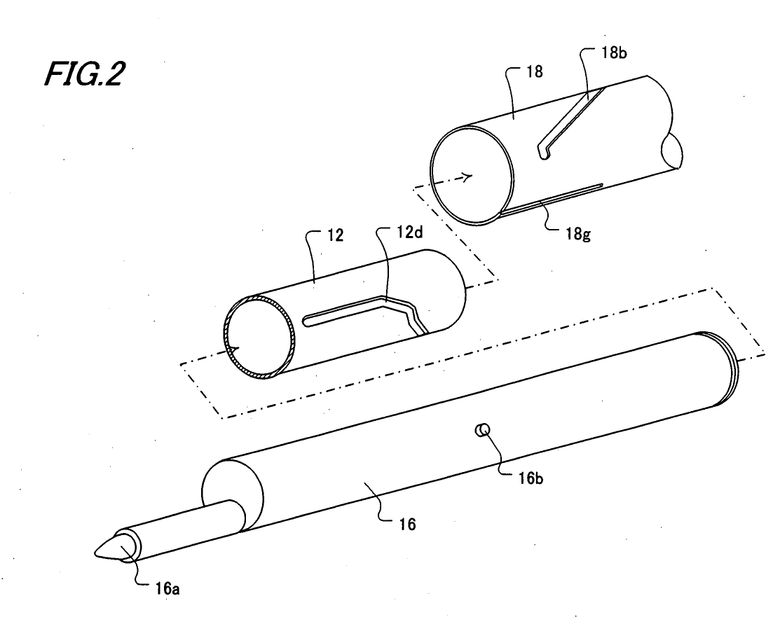

As shown in FIG. 2, an engaging projection 16b is formed on an outer circumferential surface of the general part of the refill 16 other than its pen tip 16a. A guide groove 12d is formed on a peripheral surface of the rear portion of the cylinder 12. A cam groove 18b is formed on a peripheral surface of a front portion of the rotating cylinder 18. The engaging projection 16b of the refill 16 is slidably fitted in the cam groove 18b and the guide groove 12d. The engaging projection 16b, the cam groove 18b, and the guide groove 12d cooperate with one another in controlling the movement of the refill 16 between a projected position and a housed position.

The cam groove 18b of the rotating cylinder 18 guides the engaging projection 16b mainly forward and backward. As shown in FIG. 7C, the cam groove 18b is V-shaped so that the wider part of the letter V corresponds to the front of the device. The cam groove 18b is composed of a first cam groove 18c which is long and which is inclined relative to the axial direction and a second cam groove 18d which is shorter and which is inclined in a direction opposite to that of the first cam groove 18c relative to the axial direction. A rear end portion of the first cam groove 18c is connected to a rear end portion of the second cam groove 18d. Stopper sections 18e and 18f extending in a circumferential direction are formed at respective distal ends of the first and second cam grooves 18c and 18d. Furthermore, a slit 18g (see FIG. 2) is formed in an area of a peripheral surface of the front portion of the rotating cylinder 18 which area is different from the one where the cam groove 18b is formed. The slit 18g is used to increase the diameter of the rotating cylinder 18 during an assembly operation when the engaging projection 16b is fitted into the cam groove 18b.

The guide groove 12d of the cylinder 12 guides the engaging projection 16b mainly in a rotating direction. As shown in FIG. 5E, the guide groove 12d is U-shaped and is composed of a first guide groove 12e that is long and parallel with the axial direction, a second guide groove 12f that is orthogonal to the axial direction and generally parallel with the circumferential direction, and a third guide groove 12g that is short and parallel with the axial direction. The first guide groove 12e is slightly inclined in the axial direction in its rear portion. However, a rear end portion of the first guide groove 12e and one end portion of the second guide groove 12f are connected together. A rear end portion of the third guide groove 12g and the other end portion of the second guide groove 12f are connected together.

The second guide groove 12f further has a small first inclined portion 12f1 and a small second inclined portion 12f2 both inclined in the axial direction. Furthermore, a transverse guide groove 12f3 is formed between an end portion of the first guide groove 12e and the first inclined portion 12f1. A transverse guide groove 12f4 is formed between the first inclined portion 12f1 and the second inclined portion 12f2. A transverse guide groove 12f5 is formed between the second inclined portion 12f2 and the third guide groove 12g.

An insertion port 12h is further formed in the peripheral surface of the rear portion of the cylinder 12 so as to connect a rear end of the cylinder 12 to the second guide groove 12f. The insertion port 12h is used to fit the engaging projection 16b into the guide groove 12d during assembly.

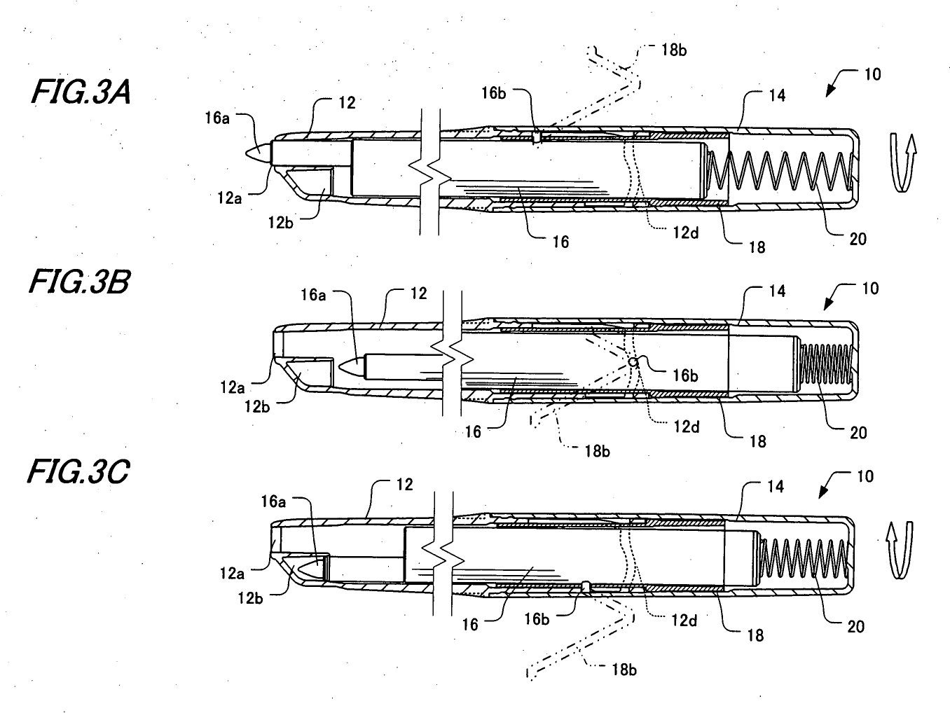

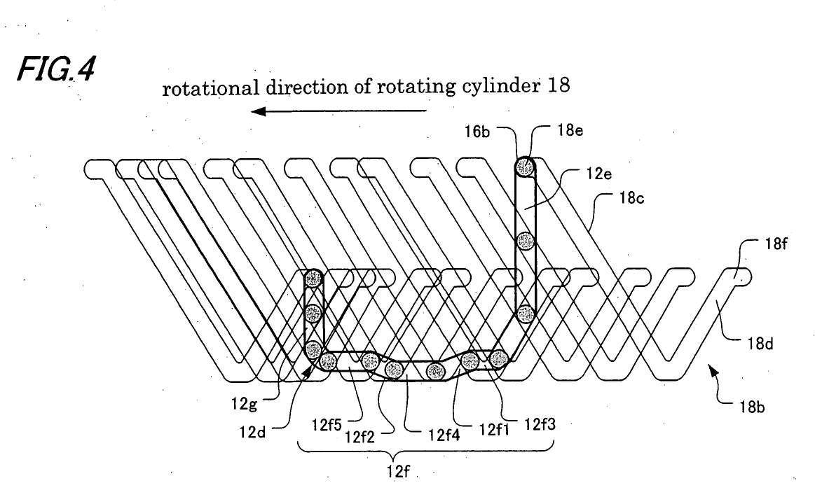

With reference to FIGS. 3 and 4, description will be given of operations of the capless holding device 10 configured as described above. First, when the refill 16 is at the projected position, the engaging projection 16b is positioned in a stopper section 18e located at a distal end portion of the first cam groove 18c of the cam groove 18b, and in a distal end portion of the first guide groove 12e of the guide groove 12d. In other words, the rotating cylinder 18 and the cylinder 12 establishes the positional relationship in which the stopper section 18e located at the distal end of the first cam groove 18c in the rotating cylinder 18 coincides with the distal end portion of the first guide groove 12e in the cylinder 12. Then, when the pin tip 16a is pressed against a surface of a sheet or the like for writing, pressure is exerted on the pen tip 16a. However, the engaging projection 16b is prevented from backward movement by the stopper section 18e. This allows the pen tip 16a to be used.

Then, to finish the use of the refill 16 and house the pen tip 16a, the rear cylinder 14 is rotated in a predetermined direction relative to the cylinder 12. The rotating cylinder 18 rotates relative to the cylinder 12 in unison with rotation of the rear cylinder 14. The engaging projection 16b is positioned in the first guide groove 12e. The first guide groove 12e hinders the engaging projection 16b from rotating with the rotating cylinder 18. Thus, the engaging projection 16b moves out of the stopper section 18e and then retracts in the axial direction along the first cam groove 18c and the first guide groove 12e. Consequently, the refill 16 retracts linearly in the axial direction relative to the cylinder 12.

The engaging projection 16b retracts through the first cam groove 18c and the first guide groove 12e. Then, before reaching a top portion of the V shape of the cam groove 18b, the engaging projection 16b moves to the transverse guide groove 12f3 of the second guide groove 12f. The engaging portion 16b is then guided in the circumferential direction, that is, in the rotating direction by the transverse guide groove 12f3. At this time, it is important that the rear end portion (proximal end portion) of the first cam groove 18c does not coincide with the rear end portion (proximal end portion) of the first guide groove 12e. This means that the top portion of the V shape of the cam groove 18b does not coincide with the junction between the first guide groove 12e and the second guide groove 12f. If they coincided with each other, the engaging projection 16b having reached the rear end portion of the first cam groove 18c would not move to the second guide groove 12f but advance linearly again along the second cam groove 18d and the first guide groove 12e. Accordingly, to ensure that the engaging projection 16b moves from the first guide groove 12e to the second guide groove 12f, the junction between the first guide groove 12e and the second guide groove 12f crosses the first cam groove 18c in front of the rear end portion (proximal end portion) of the first cam groove 18c, that is, in front of the top portion of the V shape of the cam groove 18b.

Thus, the engaging projection 16b moves to the transverse guide groove 12f3 of the second guide groove 12f, which is generally parallel with the circumferential direction. At this time, the engaging projection 16b is guided in the circumferential direction, that is, in the rotating direction by the second guide groove 12f. The engaging projection 16b is thus rotated around the axis relative to the cylinder 12. The engaging projection 16b passes through the first inclined portion 12f1 of the second guide groove 12f and then through the transverse guide groove 12f4. While moving through the transverse guide groove 12f4, the engaging projection 16b is located in substantially the top portion of the V shape of the cam groove 18b. That is, in this positional relationship, the transverse guide groove 12f4 can cross the top portion of the V shape of the cam groove 18b. Then, upon reaching the second inclined portion 12f2, the engaging projection 16b moves into a side of the second cam groove 18d in substantially the top portion of the V shape of the cam groove 18b. Importantly, the second inclined portion 12f2 allows the engaging projection 16b, which is in the top portion of the V shape of the second cam groove 18b, to move from a rear end portion of the first cam groove 18c and to abut against a wall surface of the rear end portion of the second cam groove 18d so that the switching is carried out. If the second inclined portion 12f2 were not provided and the second guide groove 12f were connected directly to the third guide groove 12g, the engaging projection 16b would attempt to move to the first cam groove 18c to cause meshing, resulting in malfunctioning.

The engaging projection 16b thus shifted to the second cam groove 18d is guided in the circumferential direction, that is, in the rotating direction by the transverse guide groove 12f5. The engaging projection 16b then reaches the third guide groove 12g. Thus, the engaging projection 16b, that is, the refill 16 cannot rotate relative to the cylinder 12 but advances along the third guide groove 12g and the second cam groove 18d. That is, the refill 16 advances linearly in the axial direction relative to the cylinder 12. The refill 16 finally moves to the stopper groove 18f, located at the distal end portion of the second cam groove 18d. This movement places the pen tip 16a of the refill 16 in the housing section 12b of the cylinder 12. The pen tip 16a is then sealed by the housing section 12b, and the refill 16 is placed in the housed position.

While the refill 16 is in the housed position, the pen tip 16a is urged by the spring 20 so as to be housed in the housing section 12b. Accordingly, the stopper groove 18f may be omitted.

In order to move the refill 16 from the housed position to the projected position, the rear cylinder 14 is rotated in the direction opposite to the one described above. It will be obvious that in this case, the operations of the transverse guides 12f5 and 12f3 are reversed, and the operations of the first and second inclined portions 12f1 and 12f2 are reversed. Accordingly, the junction between the second guide groove 12f and the third guide groove 12g crosses the second cam groove 18d in front of the rear end portion (proximal end portion) of the second cam groove 18d, that is, in front of the top portion of the V shape of the cam groove 18b.

As described above, the refill 16 can be reliably moved between the projected position and the housed position using the engaging projection 16b of the refill 16, the guide groove 12d in the cylinder 12, and the cam groove 18b in the rotating cylinder 18.

In this embodiment, the rear cylinder 14 is provided, which rotates integrally with the rotating cylinder 18 to rotate it. However, the rear cylinder 14 may be omitted and the rotating cylinder 18 may be directly rotated.

Alternatively, it is possible to provide an operation member connected to the rear cylinder 14 via a rotating cam mechanism or the like so that the rear cylinder 14 is rotated by knocking the operation member relative to the cylinder. With this arrangement, each knocking operation switches the rotating direction of the rear cylinder 14.

Alternatively, in this embodiment, an integrally constructed part, for example, the cylinder, rotating cylinder, or refill may of course be composed of a plurality of connected parts. For example, a medium as a refill may of course be composed of a plurality of parts including one having a tip and one having an engaging projection.

Moreover, in this embodiment, capless writing implements have been explained as an example of a capless holding device. However, the present invention is applicable not only to such stationary but also to capless cosmetics. The medium may include not only a refill holding ink but also a solid paste, a lipstick, an eye pencil, an eyeliner, and an eyebrow pencil.

As described above, according to the present invention, the engaging projection is guided by the cam groove formed in the rotor to guide the engaging projection forward and backward in unison with the rotation of the rotor and by the guide groove formed in the axial cylinder to guide the engaging projection in the rotating direction. Consequently, the medium can be surely retracted from the projected position, rotated, and then advanced to the housed position. Conversely, the medium can be surely retracted from the housed position, rotated, and then advanced to the projected position.

While the principles of the invention have been described above in connection with specific embodiments, and particular modifications thereof, it is to be clearly understood that this description is made only by way of example and not as a limitation on the scope of invention.

1. A capless holding device comprising a cylinder for holding a medium that is movable between a projected position and a housed position, the cylinder comprising a tip opening out of which a tip of the medium located at the projected position to be projected and a housing section for sealing the tip of the medium located at the housed position, the capless holding device comprising:
a rotor connected to the cylinder so as to relatively rotatively movable;
an engaging projection provided on the medium; and,
a cam groove formed on the rotor to guide the engaging projection forward and backward in unison with rotation of the rotor,
wherein a guide groove is formed on the cylinder to guide the engaging projection in a rotating direction, and the cam groove, the guide groove and the engaging projection cooperate with one another in retracting the medium from the projected position, rotating the medium, and then advancing the medium to the housed position and in retracting the medium from the housed position, rotating the medium, and then advancing the medium to the projected position.

2. The capless holding device according to claim 1, wherein said cam groove is V-shaped and comprises a first cam groove and a second cam groove which are inclined in opposite directions relative to an axial direction, said guide groove is U-shaped and comprises a first guide groove substantially parallel with the axial direction, a second guide groove substantially extending in a circumferential direction, and a third guide groove substantially parallel with the axial direction, and the engaging projection can take the projected position when positioned in the first cam groove and in the first guide groove and can take the housed position when positioned in the second cam groove and in the third guide groove.

3. The capless holding device according to claim 2, wherein a junction between said first guide groove and said second guide groove crosses said first cam groove in front of a top portion of the V-shaped cam groove, and a junction between said third guide groove and said second guide groove crosses said second cam groove in front of the top portion of the V-shaped cam groove.

4. The capless holding device according to claim 2, wherein said second guide groove has a small first inclined portion and a small second inclined portion both of which are inclined in the axial direction and a transverse guide groove between the first inclined portion and the second inclined portion, and the transverse guide groove can cross the top portion of the V-shaped cam groove.

5. The capless holding device according to claim 3, wherein said second guide groove has a small first inclined portion and a small second inclined portion both of which are inclined in the axial direction and a transverse guide groove between the first inclined portion and the second inclined portion, and the transverse guide groove can cross the top portion of the V-shaped cam groove.
